(19) United States
(12) Patent Application Publication
(10) Pub. No.: US 2023/0415624 A1
(43) Pub. Date: Dec. 28, 2023

(54) NON-WOVEN POROUS THREE-DIMENSIONAL MATRIX STRUCTURE FOR VEHICLE APPLICATIONS

(71) Applicant: FREUDENBERG PERFORMANCE MATERIALS LP, Durham, NC (US)

(72) Inventors: Lori HASCHER, Asheville, NC (US); Lawrence Arthur HIGBY, Jr., Gastonia, NC (US); Robinson Camden Perkins CLAYTOR, Gibsonville, NC (US); James E. MATHIS, II, Canton, NC (US)

(21) Appl. No.: 18/342,990

(22) Filed: Jun. 28, 2023

Related U.S. Application Data
(60) Provisional application No. 63/367,184, filed on Jun. 28, 2022.

(51) Int. Cl. B60N 2/56; B60N 2/70

(52) U.S. Cl. CPC B60N 2/5657; B60N 2/70

(57) ABSTRACT

The formation of a non-woven porous three-dimensional (3D) matrix structure that is particularly suitable for vehicle applications, such as in vehicle foam seating, to replace a portion of the foam while maintaining cushioning and defining relatively efficient airflow passageways for heating and cooling.

### CROSS-REFERENCE TO PRIOR APPLICATION

This application claims priority to and the benefit of U.S. Provisional Application No. 63/367,184 filed Jun. 28, 2022, the entirety of which is hereby incorporated by reference.

### FIELD

The present invention is directed at the formation of a non-woven porous three-dimensional (3D) matrix structure that is particularly suitable for vehicle applications, such as in vehicle foam seating, to replace a portion of the foam while maintaining cushioning and defining relatively efficient airflow passageways for heating and cooling.

### BACKGROUND

Knitted fabrics and/or reticulated foam have been reported for use as spacer fabrics, in vehicle seat trim covers and through/around foam cushions. The spacer fabric is reference to the feature that such material allows for airflow for seats, and in particular in seats configured with active cooling or heating while under compression. The materials are therefore targeted to allow for air to pass through their construction and provide for relatively more efficient cooling and heating. A static air space may be desirable to provide insulation.

A need nevertheless remains for three-dimensional (3D) materials that are relatively easier to form into a desired shape and have the ability to compress and recover along with relatively enhanced airflow performance that offers relatively more efficient vehicle seat cooling and heating performance.

### SUMMARY

A ventilated vehicular seat comprising polymeric foam wherein a portion of the foam is replaced with a three-dimensional non-woven self-supporting matrix structure, wherein the three-dimensional non-woven self-supporting matrix structure: (a) has a thickness in the range of 2.0 mm to 30.0 mm; (b) indicates a thickness retention at 100 lbs/ft² of 50.0% to 100%; and (c) an ASTM D 737 airflow at 125 Pa of greater than or equal to 800 cubic feet per minute.

A method of forming a ventilated vehicle seat comprising providing polymeric foam configured for a vehicle seat and replacing a portion of the foam with a three-dimensional non-woven self-supporting matrix structure, wherein the three-dimensional non-woven self-supporting matrix structure: (a) has a thickness in the range of 2.0 mm to 30.0 mm; (b) indicates a thickness retention at 100 lbs/ft² of 50.0% to 100%; and (c) an ASTM D 737 airflow at 125 Pa of greater than or equal to 800 cubic feet per minute.

### BRIEF DESCRIPTION OF THE DRAWINGS

FIG. 1 is a cross-sectional view of a portion of vehicle seating wherein portions of the foam are replaced by an insert of porous 3D self-supporting non-woven matrix structure.

FIG. 2A is another cross-sectional view of a portion of the vehicle seating wherein the porous 3D self-supporting non-woven matrix structure replaces a portion of the vehicle foam in the lower portion of the vehicle seating.

FIG. 2B is another cross-sectional view of a portion of the vehicle seating wherein the porous 3D self-supporting non-woven matrix structure replaces a portion of the vehicle foam in the lower portion of the vehicle seating, where the weight of the passenger engaged with the vehicle seating is illustrated.

FIG. 3A is another cross-sectional view of a portion of the vehicle seating wherein the porous 3D self-supporting non-woven matrix structure replaces a portion of the vehicle foam in the lower portion of the vehicle seating, which illustrates the preferred position of the HVAC system fan.

FIG. 3B is another cross-sectional view of a portion of the vehicle seating wherein the porous 3D self-supporting non-woven matrix structure replaces a portion of the vehicle foam in the lower portion of the vehicle seating, which illustrates how the weight of a typical passenger does not interfere with the operation of the HVAC system fan.

FIG. 4 provides another cross-sectional view of vehicle seating illustrating how the porous 3D self-supporting non-woven matrix structure provides airflow passageways in the foam.

### DETAILED DESCRIPTION

The present invention is directed at a non-woven porous three-dimensional (3D) matrix structure that is used to attach to and/or replace a portion of foam material utilized in ventilated vehicle seating. The non-woven porous 3D matrix structure is preferably one that is self-supporting, which is reference to the feature that the 3D matrix structure can support itself under its own weight and can therefore serve to reinforce a foam, maintain requisite cushioning, and define air passageways, when replacing a portion of a foam material.

The non-woven porous self-supporting 3D matrix structure herein is preferably selected from a nonwoven composed of filaments that are fused at their intersections. Preferably, the filaments are thermoplastic filaments, sourced from polyethylene, polypropylene, metallocene polymerized polyolefins, polyamide, or polyurethanes. Particularly preferred filaments are sourced from polyamides. Other preferred materials for use as the self-supporting 3D matrix herein include for example Enkamat® nylon mats available from Colbond (Enka, N.C.). In addition, the non-woven porous self-supporting 3D matrix structure herein can employ the three-dimensional structured mat that is described in WO2018/206568, whose teachings are incorporated by reference.

The filaments of the porous self-supporting 3D matrix structure therefore preferably comprise extruded polymeric filaments. Accordingly, the porous self-supporting 3D structure is provided by extruding polymeric filaments and collecting the extruded filaments into a 3D structure by allowing the filaments to bend, to entangle and come in contact with each other, in the molten state. The bending and entangling of the extruded filaments may be initiated by collecting the filaments onto a profiled surface, which then can define the self-supporting 3D structure herein.

The self-supporting 3D structure herein may be shaped in any desired 3D form, such as for example a series of hills and valleys either being spaced apart by a specified distance or abutted to each other and either being placed in parallel lines or in staggered formation.

The diameter of the extruded entangled filaments within the porous self-supporting 3D structure herein may have an average diameter of 100 μm to 2000 μm, more preferably in the range of 200 μm to 1500 μm, even more preferably in the range of 300 μm to 1100 μm, and most preferably 500 μm to 900 μm. As noted, the filaments of the porous self-supporting 3D matrix structure herein are thermally bonded at their crossing points. Preferably, the filaments have a weight in thickness in the range of 100 g/m 2 to 1500 g/m², more preferably 300 g/m 2 to 800 g/m², or even more preferably 300 g/m 2 to 400 g/m². The filaments also preferably have an open area of at least 75 vol. %, preferably at least 90 vol. %, more preferably at least 95 vol. %.

Preferably, the porous-self-supporting 3D non-woven matrix herein has a thickness in the range of 2.0 mm to 30.0 mm, including all individual values and increments therein. For example, in one particularly preferred embodiment, the porous self-supporting 3D nonwoven matrix herein has a thickness of 10.0 mm, 11.0 mm. 12.0 mm, 13.0 mm, 14.0 mm, 15.0 mm, 16.0 mm, 17.0 mm, 18.0 mm, 19.0 mm or 20.0 mm. In addition, the porous self-supporting 3D nonwoven matrix herein preferably has a relatively consistent thickness, which is reference to the feature that the thickness would not vary by more than +/−1.0 mm, or +/−0.5 mm, or +/−0.1 mm. By way of further example, the self-supporting 3D non-woven matrix herein may preferably have a thickness of 15.0 mm, and would not vary in thickness by more than +/−1.0 mm, or +/−0.5 mm, or +/−0.1 mm.

The porous 3D self-supporting non-woven matrix herein preferably is one that has a weight that falls in the range of 5 ounces per square yard (160.5 g/m²) to 30.0 ounces per square yard (1017.2 g/m²), including all individual values and increments therein, at the above referenced thickness of 2.0 mm to 30.0 mm. At least 90% of the self-supporting non-woven matrix is open and the mat indicates a resiliency under ASTM D6524 of at least 70% or more, more preferably in the range of 70% to 90%, including all individual values and increments therein. The 3D porous self-supporting non-woven matrix herein also preferably indicates a maximum load tensile strength, in the machine direction (direction of the 3D non-woven matrix as it is produced), in the range of 20 to 60 pounds force, a Young's modulus value in the range of 0.05 to 0.11 kilograms per square inch and a maximum percent elongation in the range of 50 to 110 percent determined using ASTM D6818 method tested at 12 inches per minute, gage length of 3 inches and 4 inch wide specimen. The 3D porous self-supporting non-woven matrix herein also preferably indicates a maximum load tensile strength in the cross-direction (perpendicular direction across the 3D non-woven matrix as it is produced) in the range of 40 to 120 pounds force, a Young's modulus value in the range of 0.2 to 0.8 kilograms per square inch and an elongation in the range of 10 to 50 percent using ASTM D6818 method tested at 12 inches per minute, gage length of 3 inches and 4 inch wide specimen.

The porous 3D self-supporting non-woven matrix herein is also one that preferably provides an indentation force deflection, according to ASTM D357B, on a 4.0 inch sample, at 25% deflection, of 42 lbs to 55 lbs. In addition, the porous 3D self-supporting non-woven matrix herein is one that preferably indicates a thickness retention at 100 lbs/square foot of 50.0% to 100%, or a thickness retention at 200 lbs/square foot of 25.0% to 95.0%.

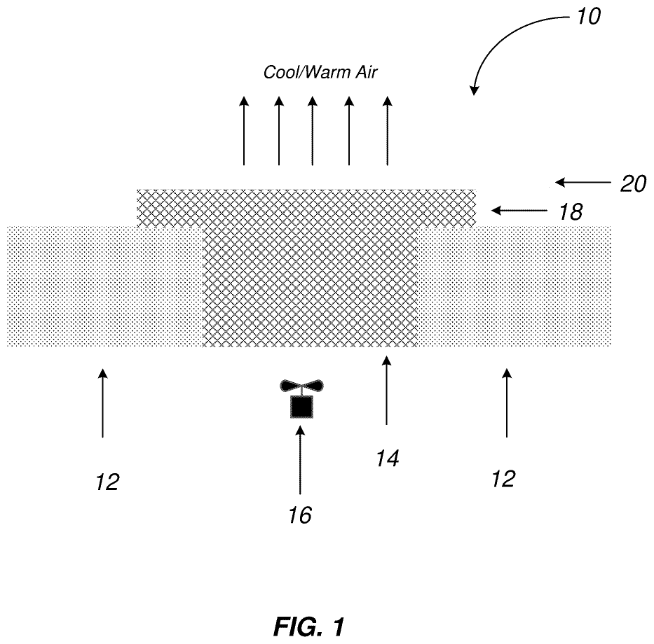

The porous 3D self-supporting non-woven matrix herein is contemplated to be particularly suitable in air-cooled/heated vehicular seating. As illustrated in FIG. 1, which is a cross-sectional view of a portion of the vehicle seating 10, the foam portions are identified at 12 and the insert of the porous 3D self-supporting non-woven matrix structure appears as item 14. As can be seen, the insert 14 of the porous 3D self-supporting non-woven matrix structure replaces a portion of the foam and preferably contains 5.0% by weight or less by weight of embedded foam within the 3D structure, and even more preferably, 3.0% by weight or less of embedded foam, and even more preferably 2.0% by weight or less, and finally, the 3D structure preferably does not contain any embedded foam.

The vehicle HVAC system fan 16 is then able to drive cool/warm air through the porous self-supporting 3D non-woven matrix 14 at a preferred airflow rate greater than or equal to 800 cubic feet per minute (cfm), as measured by ASTM D737 at 125 Pa. More preferably, the airflow is in the range of 800 cfm to 1360 cfm. As also illustrated, one can preferably include a spacer layer 18 of the porous 3D self-supporting 3D nonwoven under the cover stock layer 20. The spacer layer itself may have a preferred thickness in the range of 3.0 mm to 20.0 mm and provide a similar airflow rate in the range of 800 cfm to 1360 cfm. The HVAC system fan 16 is therefore now able to drive cool/warm air through the porous 3D self-supporting non-woven matrix 14 and spacer layer 18 and then through the cover stock layer 20 as may be set by a vehicle passenger when implementing the vehicle HVAC system 16.

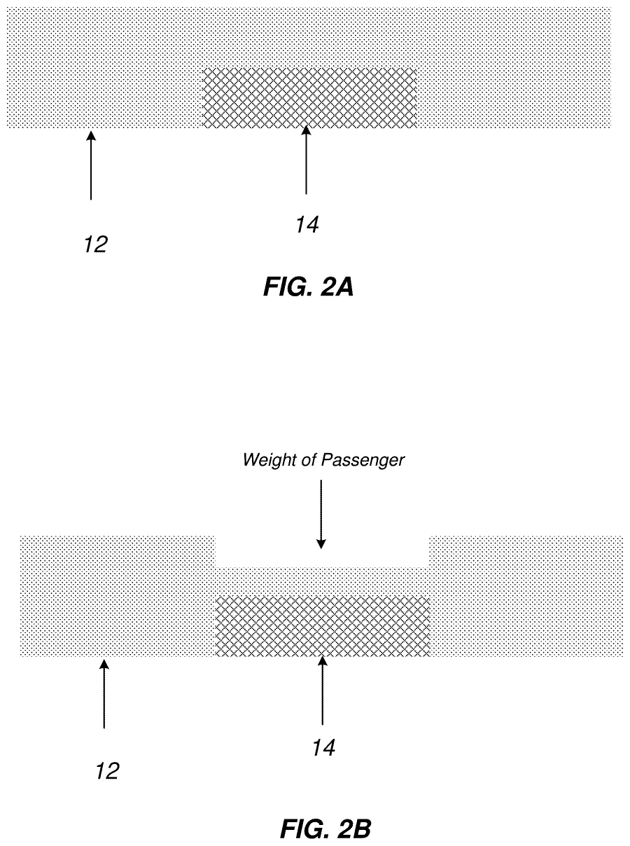

FIGS. 2A and 2B illustrate again in cross-section a view of a portion of the vehicle seating, the feature herein wherein the porous 3D self-supporting non-woven matrix 14 inserts and replaces a portion of the vehicle foam 12 in the lower portion of the vehicle seating. As may now be appreciated, the porous 3D self-supporting non-woven matrix 14 can otherwise function as a duct, channel or tunnel for the flow of cooled/warm air driven by the vehicle HVAC system fan 16.

FIG. 2B illustrates in cross-section the vehicle seating of FIG. 2A, where a passenger has engaged with the vehicle seating and placed their weight thereon. The cover stock 20 and spacer layer 18 have been removed for clarity. As can be observed, while a portion of the foam 12 may compress, the porous 3D self-supporting non-woven matrix 14 preferably does not compress or indicates the thickness retention noted herein, and the ability of the porous 3D non-woven matrix 14 is preserved so that it may continue to provide pathways in the form of a duct, channel or tunnel for the flow of cool/warm air.

It should be appreciated that in the absence of the porous 3D non-woven matrix 14, the weight of the passenger would otherwise cause the foam to compress, and the deformed foam would then reduce any cut-out space in the foam for the flow of air. The ability of the porous 3D non-woven matrix to therefore provide limited compression under the weight of a typical passenger (50 lbs to 300 lbs) thus provides a more efficient vehicle seating configuration, at relatively lighter overall weight, that also preserves the efficiency of the HVAC system when operating within the vehicle. In such context, for a given thickness of the porous 3D non-woven matrix herein is one that indicates a thickness retention at 100 lbs/ft² pressure of 50-100%, or a thickness retention at 200 lbs\ft² of 25% to 95%.

Table 1 below shows the thickness retention under pressure for the porous 3D non-woven self-supporting matrix material herein:

TABLE 1
Thickness Retention

| | Thickness Retention Under Pressure of | | | | |
|---|---|---|---|---|---|
| | The Porous 3D Non-Woven Matrix | | | | |
| | 12 oz/yd² | 14 oz/yd² | | 13 oz/yd² | 12 oz/yd² |
| | 10.0 mm | 10.0 mm | | 10.0 mm | 10.0 mm |
| Pressure | Thick | Thick | 16 oz/yd² | Thick | Thick |
| (lbs/ft²) | FB75-25 | FB75-25 | FB 75/25 | FB 60/40 | FB 60/40 |
| 0 | 1 | 1 | 1 | 1 | 1 |
| 100 | 0.887 | 0.910 | 0.907 | 0.808 | 0.813 |
| 200 | 0.844 | 0.880 | 0.892 | 0.698 | 0.650 |
| 500 | 0.476 | 0.749 | 0.842 | 0.379 | 0.341 |
| 1000 | 0.266 | 0.357 | 0.413 | 0.239 | 0.230 |
| 2000 | 0.192 | 0.239 | 0.260 | 0.176 | 0.174 |
| 3000 | 0.160 | 0.199 | 0.214 | 0.149 | 0.149 |

In the above Table, FB indicates flat back, meaning that the back of the material is intentionally flat without peaks. The reference to 75/25 identifies that 75% of the weight of the material is in the bulk and 25% on the surface (flat back). The reference to 60/40 indicates that 60% of the weight of the material is in the bulk and 40% on the surface (flat back). As can be seen from the above thickness retention evaluation, the porous 3D non-woven self-supporting non-woven matrix structure herein more preferably retains 80.0% more of its thickness at 100 lbs/ft² and 65.0% or more of its thickness at 200 lbs/ft².

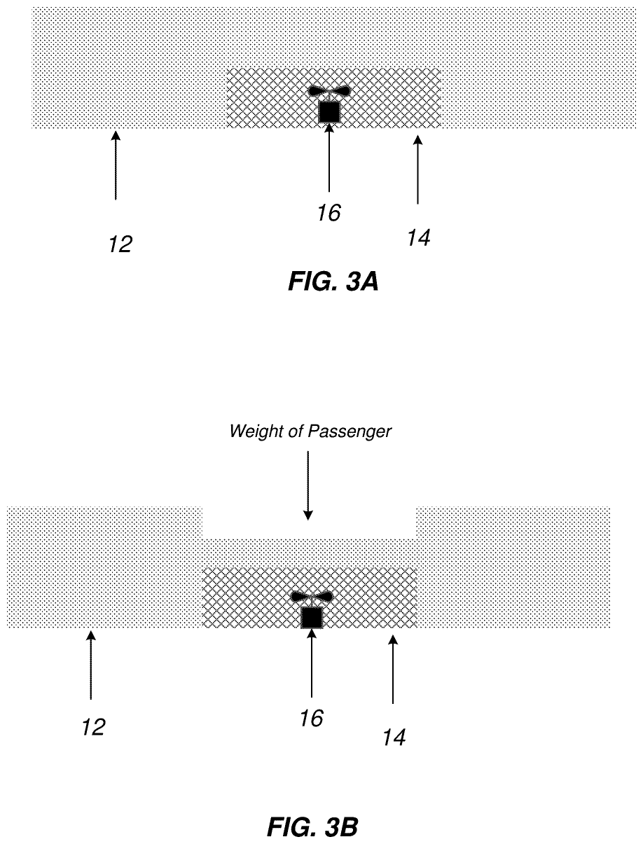

FIGS. 3A and 3B are similar to FIGS. 2A and 2B and show the additional feature of the preferred position of the HVAC system fan 16 within a cut-out region of the porous 3D non-woven matrix 14. As can be seen from FIGS. 3C and 3D, when a vehicle passenger engages with the vehicle seating, the 3D porous non-woven matrix again preferably does not fully compress and deform under the weight of a typical passenger (50 lbs to 300 lbs) and the HVAC system fan 16 is not compromised due to the presence of some compressed foam interfering with its operation.

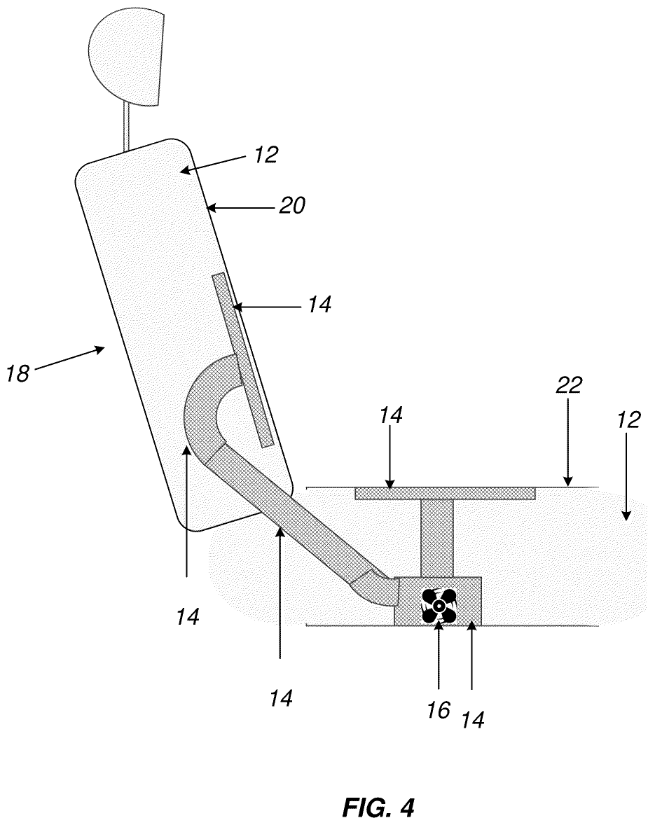

FIG. 4 provides another view as to how the porous 3D non-woven matrix 14 may be used within the vehicle seating to more effectively provide pathways in the foam 12 in the form of a duct, channel or tunnel for the flow of cool/warm air. As now shown in FIG. 4, such pathways may be positioned in both the vehicle seat backing 18 and seat cushion 20 where a portion of the foam 12 is replaced by the porous 3D non-woven matrix 14. Accordingly, it may be appreciated that one or a plurality of airflow pathways may now be provided within the foam 12 by use of the porous 3D non-woven matrix 14 herein to provide for circulation of warm/cool air with a reduction in weight and wherein such pathways are not compromised when a passenger is engaged with the vehicle seating, due to compression resistance. As noted above, the flow of air delivered at the seat back 20 or at the surface 22 of the seat cushioning preferably is maintained and falls in the preferred range of 800 cfm to 1360 cfm.

Expanding on the above, it is more specially contemplated that the porous 3D non-woven matrix 14 herein when used in vehicle foam seating, while providing the above referenced pathways for airflow, can also provide mechanical property features that are similar to the foam 12 that is employed, while also providing the aforementioned compression resistance. In particular, the preferred foam that may replace herein with a portion of the 3D nonwoven matrix 14 includes polyurethane foam having the following properties: (1) foam density of 24-48 kg/m 3; (2) foam indentation force deflection (IFD) of 25-70 (pounds force per 50 inch); thickness retention in the range of 85% to 93% at 100 lbs/ft²; thickness retention of 25% to 55% at 500 lbs/ft².

By reference to a portion of the polyurethane foam being replaced, it is contemplated herein that preferably up to 50% by weight of the preferred polyurethane foam utilized in the cushioning and seat-back may be replaced by the 3D nonwoven matrix. According, 1% by weight to 50% by weight of the polyurethane in the seat cushion and or seat-back may be replaced by the 3D nonwoven matrix herein, including all values and increments therein. For example, one may replace 10%-50% of the foam, or 20% to 50% of the foam, or 30% to 50% of the foam, or 40% to 50% of the foam with the porous self-supporting 3D nonwoven matrix structure herein.

It is further contemplated herein that the porous 3D non-woven matrix 14 herein may include the addition of layer of a spunbond non-woven, needle-punched non-woven, or knit fabric (e.g. circular knit) on the side of the porous 3D non-woven matrix that contacts the cover stock 20. Such layer of spunbond non-woven or woven fabric may preferably have a thickness in the range of up to and including 1.0 mm and a basis weight in the range of 20 gsm to 200 gsm. Such spunbond non-woven, needle punched non-woven or knit fabric may preferably be made of those polymeric resins identified for the manufacture of the 3D non-woven matrix itself. Namely, thermoplastic filaments, sourced from polyethylene, polypropylene, metallocene polymerized polyolefins, polyamide, or polyurethanes.

The porous 3D non-woven matrix 14 herein may preferably be made flame retardant. Such flame retardants preferably include non-halogenated flame retardants, which are preferably employed in the non-woven matrix 14 at a level of up to 10.0% (wt.). Other contemplated additives include antimicrobial agents such as silver, copper or zinc, which are preferably present at a level of 1.0% (wt.) to 10.0% (wt.).

The porous 3D non-woven matrix herein also indicates a number of other additional advantages when used to replace a portion of the vehicle foam seating. This includes, e.g., that the surface of the 3D non-woven matrix herein is such that it can mechanically adhere to the foam thereby obviating the use of adhesives or clip mechanism to hold the 3D non-woven matrix in place. In addition, the 3D non-woven matrix herein can be cut to a desired thickness or shape as may be necessary to replace a portion of the vehicle foam seating.

The porous 3D non-woven matrix herein may also be stacked. As noted above, the porous 3D non-woven matrix herein may have a thickness in the range of 2.0 mm to 30.0 mm. Accordingly, for a given thickness selected within this range, a plurality of such 3D non-woven matrices may then be stacked to provide a multi-layered 3D non-woven matrix.

What is claimed is:

1. A ventilated vehicular seat, comprising polymeric foam, wherein a portion of said foam is replaced with a three-dimensional non-woven self-supporting matrix structure, wherein said three-dimensional non-woven self-supporting matrix structure: (a) has a thickness in the range of 2.0 mm to 30.0 mm; (b) indicates a thickness retention at 100 lbs/ft² of 50.0% to 100%; and (c) an ASTM D 737 airflow at 125 Pa of greater than or equal to 800 cubic feet per minute.

2. The ventilated vehicular seat of claim 1, wherein up to 50% of said foam is replaced by said three-dimensional non-woven self-supporting matrix structure.

3. The ventilated vehicular seat of claim 1, wherein said ASTM D 737 airflow at 125 Pa is 800 cfm to 1360 cfm.

4. The ventilated vehicular seat of claim 1, wherein said three-dimensional non-woven self-supporting matrix structure has a basis weight of 160.5 g/m 2 to 1017.2 g/m².

5. The ventilated vehicular seat of claim 1, wherein said three-dimensional non-woven self-supporting matrix structure indicates an ASTM D 6524 resiliency of at least 70% or more.

6. The ventilated vehicular seat of claim 1, wherein said three-dimensional non-woven self-supporting matrix structure indicates a thickness retention at retention at 100 lbs/ft² of 80% or more.

7. The ventilated vehicular seat of claim 1, wherein said three-dimensional non-woven self-supporting matrix structure comprises thermoplastic filaments.

8. The ventilated vehicular seat of claim 2, wherein said thermoplastics filaments are selected from polyethylene, polypropylene, metallocene polymerized polyolefins, polyamides or polyurethanes.

9. The ventilated vehicular seat of claim 2, wherein the thermoplastic filaments have a diameter in the range of 100 μm to 2000 μm.

10. The ventilated vehicular seat of claim 1, wherein said foam comprises polyurethane foam having a foam density of 24 kg/m 3 to 48 kg/m 3.

11. The ventilated vehicular seat of claim 1, wherein said three-dimensional non-woven self-supporting matrix structure includes a layer of spunbond non-woven, needle-punched non-woven, or knit fabric at a thickness of up to 1.0 mm and a basis weight in the range of 20 gsm to 300 gsm.

12. The ventilated vehicular seat of claim 1, wherein said three-dimensional non-woven self-supporting matrix structure contains a non-halogenated flame retardant.

13. The ventilated vehicular seat of claim 1, wherein said three-dimensional non-woven self-supporting matrix structure contains an antimicrobial agent.

14. The ventilated vehicular seat of claim 1, wherein said three-dimensional non-woven self-supporting matrix structure contains 5.0% or less of foam embedded within said three-dimensional structure.

15. A method of forming a ventilated vehicle seat comprising:
a. providing polymeric foam configured for a vehicle seat;
b. replacing a portion of said foam with a three-dimensional non-woven self-supporting matrix structure, wherein said three-dimensional non-woven self-supporting matrix structure: (a) has a thickness in the range of 2.0 mm to 30.0 mm; (b) indicates a thickness retention at 100 lbs/ft² of 50.0% to 100%; and (c) an ASTM D 737 airflow at 125 Pa of greater than or equal to 800 cubic feet per minute.

16. The method of claim 15, wherein up to 50% of said foam is replaced by said three-dimensional non-woven self-supporting matrix structure.

17. The method of claim 15, wherein said ASTM D 737 airflow at 125 Pa is 800 cfm to 1360 cfm.

18. The method of claim 15, wherein said three-dimensional non-woven self-supporting matrix structure has a basis weight of 160.5 g/m 2 to 1017.2 g/m².

19. The method of claim 15, wherein said three-dimensional non-woven self-supporting matrix structure indicates an ASTM D 6524 resiliency of at least 70% or more.

20. The method of claim 15, wherein said three-dimensional non-woven self-supporting matrix structure indicates a thickness retention at retention at 100 lbs/ft² of 80% or more.
